(19) United States
(12) Patent Application Publication
(10) Pub. No.: US 2025/0192445 A1
(43) Pub. Date: Jun. 12, 2025

(54) ANTENNA DEVICE

(71) Applicant: KMW INC., Hwaseong-si (KR)

(72) Inventors: Young Chan MOON, Suwon-si (KR); Sung Hwan SO, Hwaseong-si (KR); Oh Seog CHOI, Hwaseong-si (KR); Yong Won SEO, Hwaseong-si (KR); Myung Hwa KIM, Hwaseong-si (KR); Jang Soon PARK, Hwaseong-si (KR); Hyoung Seok YANG, Hwaseong-si (KR); Seong Man KANG, Hwaseong-si (KR)

(73) Assignee: KMW INC., Hwaseong-si (KR)

(21) Appl. No.: 19/052,257

(22) Filed: Feb. 12, 2025

Related U.S. Application Data
(63) Continuation of application No. PCT/KR2023/012185, filed on Aug. 17, 2023.

(30) Foreign Application Priority Data
Aug. 24, 2022 (KR) 10-2022-0106256
Aug. 10, 2023 (KR) 10-2023-0105031

(51) Int. Cl. H01Q 21/06; H01Q 1/42

(52) U.S. Cl. CPC H01Q 21/061; H01Q 1/425

(57) ABSTRACT

According to an embodiment of the present disclosure, provided is an antenna device comprising: at least one base substrate; a plurality of antenna elements disposed on the at least one base substrate in a height direction perpendicular to the at least one base substrate and supported by the at least one base substrate; and a radome spaced apart from the plurality of antenna elements in the height direction and configured to surround the at least one base substrate and the plurality of antenna elements, wherein the radome includes a pattern portion disposed on a surface facing the plurality of antenna elements and configured to be able to decouple electromagnetic waves radiated from the plurality of antenna elements.

### TECHNICAL FIELD

The present disclosure relates to an antenna device. In more detail, the present disclosure relates to an antenna device including a decoupling structure.

### BACKGROUND ART

The description of this part only provides the background information of the present disclosure without configuring the related art.

Wireless communication systems require an increasingly higher data transmission rate. To this end, a Massive MIMO (Multiple Input Multiple Output (MIMO) technology that can ensure reliability of communication and simultaneously increase channel capacity is being developed. A MIMO system, which is a technology that significantly increases data transmission capacity using multiple antennas, is a spatial multiplexing technique in which a transmitter transmits different data through each transmitting antenna and a receiver separates transmitted data through appropriate signal processing. Accordingly, by increasing the number of both transmitting and receiving antennas, channel capacity is increased, so it is possible to transmit more data.

However, disposing multiple antennas in situations with spatial constraints causes coupling between the antennas. When coupling between multiple antennas increases, signal leakage may occur, whereby the efficiency of an antenna device may be deteriorated.

Accordingly, there is a need for an antenna device configured to enable decoupling between antenna elements, and it is also important to ensure that the overall size of the antenna device is not increased.

### DETAILED DESCRIPTION OF INVENTION

### Technical Problems

Accordingly, the present disclosure has been made in an effort to solve the problems and an objective of the present disclosure is to provide an antenna device that can solve the problem of coupling between antenna elements without increasing the overall size of the antenna device.

### Technical Solution

According to one embodiment of the present disclosure, the present disclosure provides an antenna device comprising: at least one base substrate; a plurality of antenna elements disposed on the at least one base substrate in a height direction perpendicular to the at least one base substrate and supported by the at least one base substrate; and a radome spaced apart from the plurality of antenna elements in the height direction and configured to surround the at least one base substrate and the plurality of antenna elements, wherein the radome includes a pattern portion disposed on a surface facing the plurality of antenna elements and configured to be able to decouple electromagnetic waves radiated from the plurality of antenna elements.

### Effect of Invention

As described above, according to the embodiment, there is an effect that it is possible to provide an antenna device that can solve the problem of coupling between antenna elements without increasing the overall size of the antenna device.

### BRIEF DESCRIPTION OF THE DRAWING

FIG. 1 is a perspective view of the assembly of an antenna device according to an embodiment of the present disclosure.

FIG. 2 is an exploded perspective view of the antenna device according to an embodiment of the present disclosure.

FIG. 3A is a view showing a pattern portion of an antenna device according a first embodiment of the present disclosure.

FIG. 3B is a cross-sectional view of the antenna device according the first embodiment of the present disclosure, taken along the A-A′ direction of FIG. 1.

FIG. 4A is a view showing a pattern portion of an antenna device according a second embodiment of the present disclosure.

FIG. 4B is a cross-sectional view of the antenna device according the second embodiment of the present disclosure, taken along the A-A′ direction of FIG. 1.

FIG. 5A and FIG. 5B are views showing the isolation between some antenna elements and ports in the absence of a radome according to an embodiment of the present disclosure.

FIG. 6A to FIG. 6C are views showing the isolation between some antenna elements and ports in the presence of a radome according to an embodiment of the present disclosure.

FIG. 7 is a view comparing the isolation between some specific ports in the presence and absence of a radome according to an embodiment of the present disclosure.

### BEST MODE FOR CARRYING OUT THE INVENTION

Hereinafter, some embodiments of the present disclosure will be described in detail with reference to the accompanying drawings. It is to be noted that in giving reference numerals to components of each of the accompanying drawings, the same components will be denoted by the same reference numerals even though they are illustrated in different drawings. Further, in describing exemplary embodiments of the present invention, well-known functions or constructions will not be described in detail since they may unnecessarily obscure the understanding of the present invention.

Terms ‘first’, ‘second’, i), ii), a), b), and the like, will be used in describing components according to embodiments of the present disclosure. These terms are only for distinguishing the components from other components, and the nature, sequence, order, or the like of the components are not limited by the terms. Throughout the present specification, unless explicitly described to the contrary, “including” or “comprising” any components will be understood to imply the inclusion of other elements rather than the exclusion of any other elements.

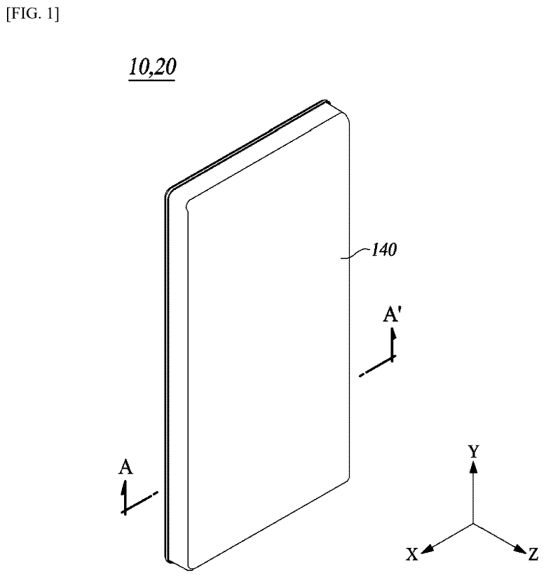

FIG. 1 is a perspective view of the assembly of an antenna device according to an embodiment of the present disclosure.

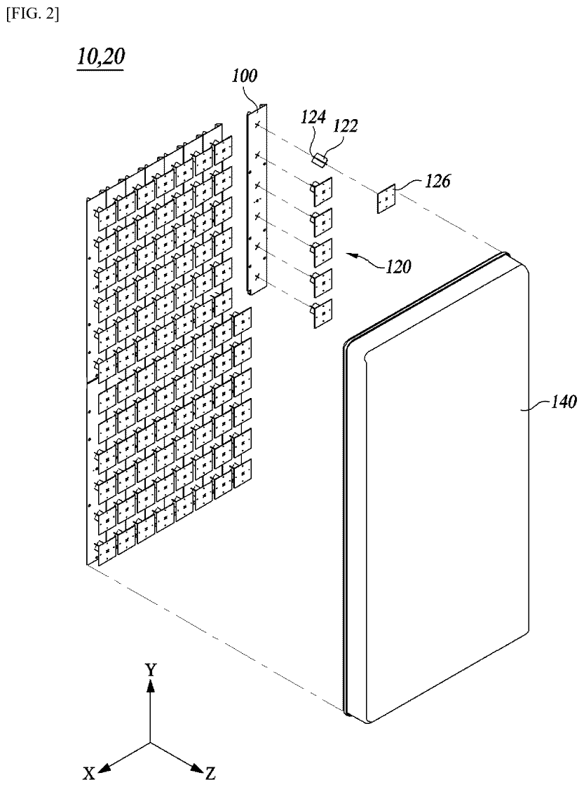

FIG. 2 is an exploded perspective view of the antenna device according to an embodiment of the present disclosure.

Referring to FIG. 1 and FIG. 2, an antenna device 10, 20 according an embodiment of the present disclosure includes all or some of at least one base substrate 100, a plurality of antenna elements 120, and a radome 140.

The base substrate 100 is configured such that a plurality of antenna elements 120 to be described below can be grounded. The base substrate 100 may be a plate-shaped member made of plastic or metal, but is not necessarily limited thereto.

Meanwhile, the base substrate 100 is configured in a total of 16 units in an (8*2) arrangement in the figures, but the arrangement and number of the base substrate 100 are not necessarily limited thereto.

A plurality of antennas 120 is supported by the base substrate 100 and is configured to be able to radiate electromagnetic waves. Further, the plurality of antennas 120 may be disposed on the base substrate 100 in a height direction perpendicular to the base substrate 100. In this case, the height direction may refer to the Z-axis direction in FIG. 1.

It is preferable that a plurality of antennas 120 is arranged on at least one base substrate 100 while forming a certain array. For example, as shown in FIG. 2, a plurality of antenna elements 120 may be configured in a total of 96 units in an (8*12) array. In this case, the number of the base substrates 100 is 16, and six antenna elements 120 may be disposed on one base substrate 100. However, as long as the plurality of antenna elements 120 forms a certain array, they are not necessarily limited to the arrangement and quantity shown in FIG. 2.

Further, each of the plurality of antenna elements 120 may include a first feeding substrate 122, a second feeding substrate 124, and a radiation plate 126.

The first feeding substrate 122 may be a printed circuit board disposed on the base substrate 100 and including a feeding line (not shown).

The second feeding substrate 124 may be a printed circuit board disposed on the base substrate 100 to intersect the first feeding substrate 122 and including a feeding line. In this case, the first feeding substrate 122 and the second feeding substrate 124 may intersect at 900 to each other but are not necessarily limited thereto.

The radiation plate 126, which is a component supported by ends of the first feeding substrate 122 and the second feeding substrate 124 in the height direction, may be a point where electromagnetic waves are radiated.

In this case, at least a portion of the ends of the first feeding substrate 122 and the second feeding substrate 124 in the height direction may protrude from the radiation plate 126 in the height direction. Further, at least a portion of the ends of the first feeding substrate 122 and the second feeding substrate 124 in a direction opposite to the height direction may protrude from the base plate 100 in the direction opposite to the height direction. For example, the first feeding substrate 122 and the second feeding substrate 124 may each be fitted to the base plate 100 and the radiation plate 126.

In this case, the upper portions of the first feeding substrate 122 and the second feeding substrate 124 are supported by the radiation plate 126 and the lower portions thereof are supported by the base substrate 100, whereby the positions of the first feeding substrate 122 and the second feeding substrate 124 can be fixed.

The radome 140 is spaced apart from the plurality of antenna elements 120 in the height direction and is configured to surround at least one base substrate 100 and a plurality of antenna elements 120. In this case, it is preferable that the gaps between a plurality of antenna elements 120 and the radome 140 are uniform for all of the plurality of antennas 120.

The radome 140 not only can protect at least one base substrate 100 and a plurality of antenna elements 120 from external factors, but can prevent the problem that may occur due to coupling between a plurality of antenna elements 120 in the present disclosure.

Meanwhile, coupling between a plurality of antenna elements 120 may be direct coupling in which a plurality of antennas is directly coupled to each other, indirect coupling in which at least some of the electromagnetic waves radiated from any one antenna elements are reflected by the radome 140 and the antenna elements are coupled to other antenna elements.

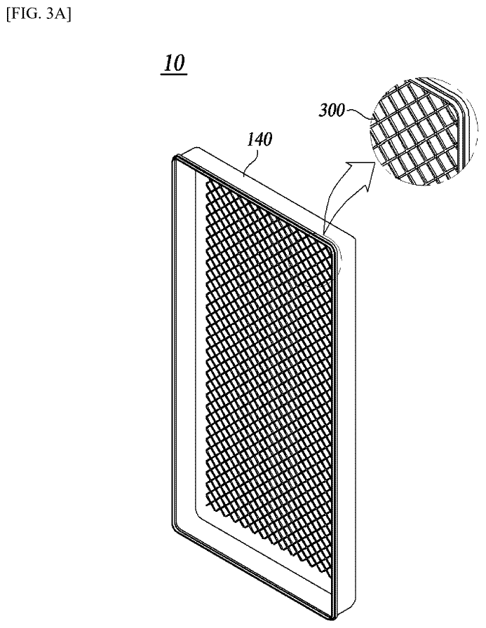

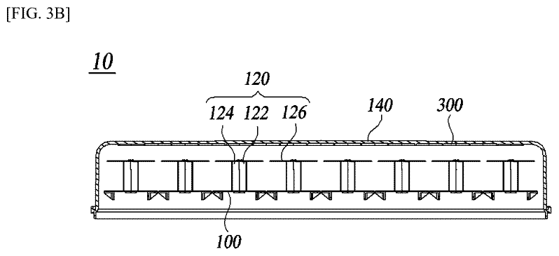

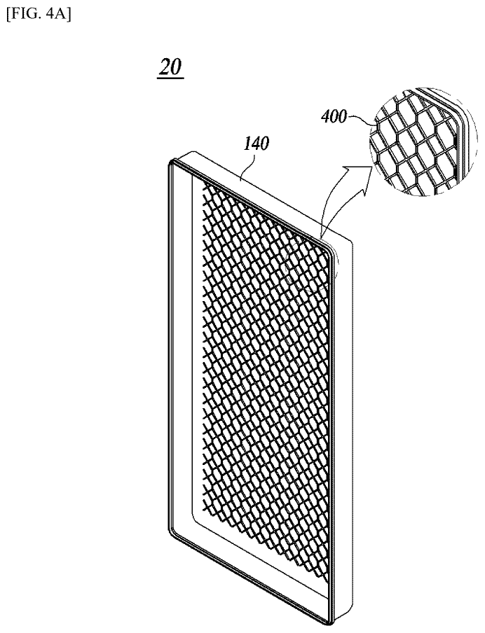

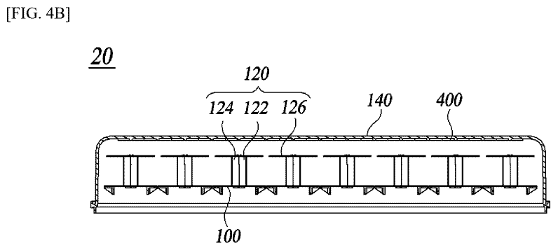

The radome 140 according to an embodiment of the present disclosure may include a pattern portion (300 in FIG. 3A and 400 in FIG. 4A) configured to be able to decouple electromagnetic waves radiated from a plurality of antenna elements. The radome 140 has the pattern portion 300, 400, thereby being able to minimize indirect decoupling between the plurality of antenna elements 120.

Further, the antenna device 10, 20 according to an embodiment of the present disclosure may further include shielding walls (not shown) disposed between the plurality of antenna elements 120 to prevent direct decoupling between the plurality of antenna elements 120.

FIG. 3A is a view showing a pattern portion of an antenna device according a first embodiment of the present disclosure.

FIG. 3B is a cross-sectional view of the antenna device according the first embodiment of the present disclosure, taken along the A-A′ direction of FIG. 1.

FIG. 4A is a view showing a pattern portion of an antenna device according a second embodiment of the present disclosure.

FIG. 4B is a cross-sectional view of the antenna device according the second embodiment of the present disclosure, taken along the A-A′ direction of FIG. 1.

Referring to FIG. 3A, the pattern portion 300 of the antenna device 10 according to a first embodiment of the present disclosure is configured such that rhombus-shaped patterns are repeatedly arranged.

Further, referring to FIG. 4A, the pattern portion 400 of the antenna device 20 according to a second embodiment of the present disclosure is configured such that hexagon-shaped patterns are repeatedly arranged.

Meanwhile, referring to FIG. 3B and FIG. 4B, some of the electromagnetic waves radiated from the radiation plate 126 pass through the radome 140, while some are reflected by the inner surface of the radome 140 and may cause coupling with other antenna elements.

The pattern portion 300, 400 according to an embodiment of the present disclosure can prevent the problem of indirect coupling between a plurality of antenna elements 120 by decoupling electromagnetic waves radiated from the radiation plate 126. To this end, it is preferable that electromagnetic waves after decoupling by the pattern portion 300, 400 have a phase opposite to the phase before decoupling.

Accordingly, it is possible to prevent various problems that may occur due to an increase of coupling between a plurality of antenna elements 120, for example, signal leakage and reduction in channel capacity of a MIMO system.

FIGS. 3A, 3B, 4A, and 4B show rhombus-shaped and hexagon-shaped patterns, but the pattern portion 300, 400 of the antenna device 10, 20 according to an embodiment of the present disclosure is not necessarily limited to those patterns.

Further, the pattern portion 300, 400 of the antenna device 10, 20 according to an embodiment of the present disclosure is disposed on a surface of the radome 140 that faces a plurality of antennas 120. For example, the pattern portion 300, 400 may be disposed on the inner surface of the radome 140, and in this case, there is no need for a separate cover for protecting the pattern portion 300, 400 from external factors and it is possible to achieve a decoupling effect between a plurality of antenna elements 120 without an increase in size of the antenna device.

Meanwhile, though shown in the figures, the radome 140 of the antenna device 10, 20 according to an embodiment of the present disclosure may include at least one rib (not shown) formed on a surface facing a plurality of antenna elements 120. In this case, the pattern portion 300, 400 may be formed on the rib.

However, it is not necessary for the pattern portion 300, 400 to be formed on the rib of the radome 140, and for example, the pattern portion 300, 400 may be configured to be attached to a surface of the radome 140 that faces a plurality of antenna elements 120 by itself.

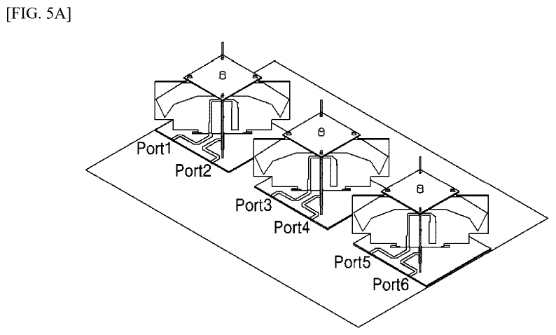

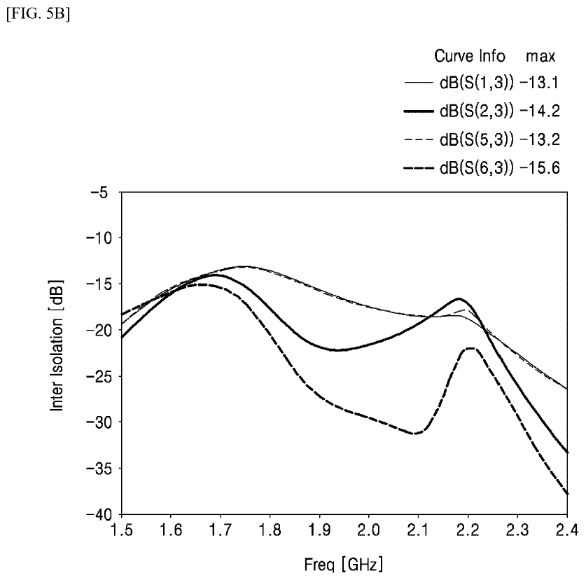

FIG. 5A and FIG. 5B are views showing the isolation between some antenna elements and ports in the absence of a radome according to an embodiment of the present disclosure.

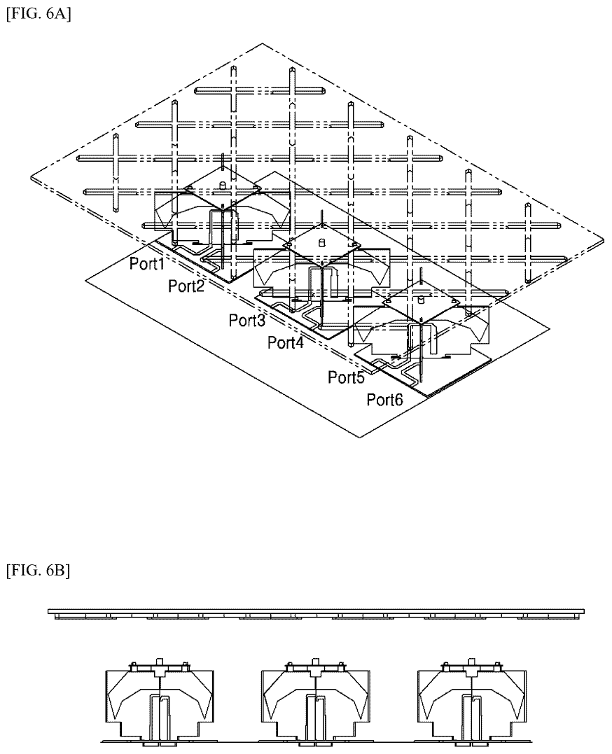

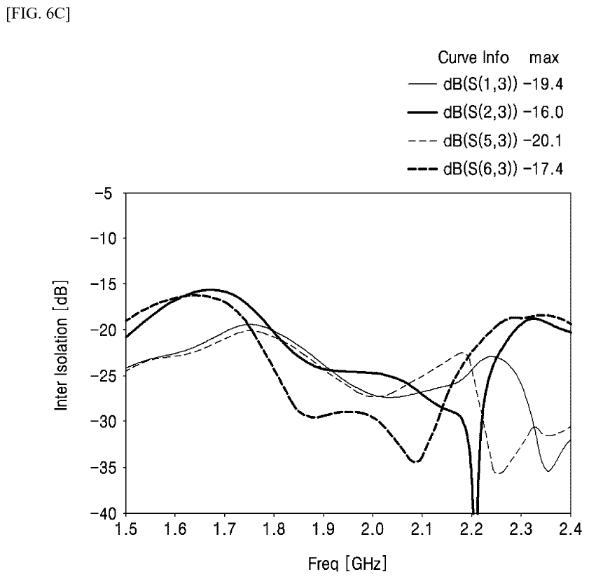

FIG. 6A to FIG. 6C are views showing the isolation between some antenna elements and ports in the presence of a radome according to an embodiment of the present disclosure.

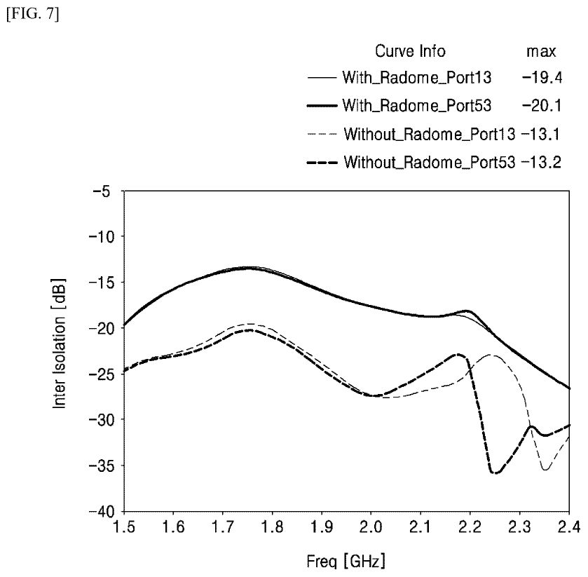

FIG. 7 is a view comparing the isolation between some specific ports in the presence and absence of a radome according to an embodiment of the present disclosure.

In FIG. 5A and FIG. 5B, and FIG. 6A to FIG. 6C, interference between a first port and a third port, interference between a second port and the third port, interference between a fifth port and the third port, and interference between a sixth port and the third port are shown and compared, as an example. However, the following effects are not necessarily limited only to the interference between the ports shown in FIG. 5A and FIG. 5B, and FIG. 6A to FIG. 6C.

Referring to FIG. 5B and FIG. 6C, generally, it can be seen that the graph values in FIG. 6C have decreased compared to the graph values in FIG. 5B and it can be seen that the absolute value of the negative between each pair of ports has increased, which means that the isolation has been improved when the radome 140 according to an embodiment of the present disclosure is included.

Meanwhile, referring to FIG. 7, the graph of a common antenna device not including the radome 140 according to an embodiment of the present disclosure is indicated by a solid line and the graphs of the antenna devices 10 and 20 including the radome 140 according to an embodiment of the present disclosure are indicated by dotted lines.

It can be seen that the graphs indicated by dotted lines show remarkably low degrees of decoupling in comparison to the graph indicated by a solid line. Accordingly, it can be seen that including the radome 140 according to an embodiment of the present disclosure is significantly effective for decoupling between a plurality of antenna elements 120.

The spirit of the present embodiment is illustratively described hereinabove. It will be appreciated by those skilled in the art to which the present embodiment pertains that various modifications and alterations may be made without departing from the essential characteristics of the present embodiment. Accordingly, the present embodiments are not to limit the spirit of the present embodiment, but are to describe the spirit of the present embodiment. The technical idea of the present embodiment is not limited to these embodiments. The scope of the present embodiment should be interpreted by the following claims, and it should be interpreted that all the spirits equivalent to the following claims fall within the scope of the present embodiment.

### DESCRIPTION OF REFERENCE NUMERALS

10, 20: antenna device, 100: base substrate, 120: plurality of antenna elements, 122: first feeding substrate, 124: second feeding substrate, 126: radiation plate, 140: radome, 300, 400: pattern portion

1. An antenna device comprising:
at least one base substrate;
a plurality of antenna elements disposed on the at least one base substrate in a height direction perpendicular to the at least one base substrate and supported by the at least one base substrate; and
a radome spaced apart from the plurality of antenna elements in the height direction and configured to surround the at least one base substrate and the plurality of antenna elements,
wherein the radome includes a pattern portion disposed on a surface facing the plurality of antenna elements and configured to be able to decouple electromagnetic waves radiated from the plurality of antenna elements.

2. The antenna device of claim 1, wherein the radome includes at least one rib formed on a surface facing the plurality of antenna elements, and
the pattern portion is formed on the rib.

3. The antenna device of claim 1, wherein the pattern portion is configured to be attached to a surface of the radome that faces the plurality of antenna elements.

4. The antenna device of claim 1, wherein the plurality of antenna elements each includes:
a first feeding substrate disposed on the base substrate;
a second feeding substrate disposed on the base substrate to intersect the first feeding substrate; and
a radiation plate supported by each end of the first feeding substrate and the second feeding substrate in the height direction.

5. The antenna device of claim 4, wherein at least a portion of each end of the first feeding substrate and the second feeding substrate in the height direction protrudes from the radiation plate in the height direction, and
at least a portion of each end of the first feeding substrate and the second feeding substrate in a direction opposite to the height direction protrudes from the at least one base plate in the direction opposite to the height direction.

6. The antenna device of claim 5, wherein each of the first feeding substrate and the second feeding substrate is fitted to the at least one base plate and the radiation plate.

7. The antenna device of claim 4, wherein the first feeding substrate and the second feeding substrate intersect at 900 to each other.

8. The antenna device of claim 1, wherein electromagnetic waves after decoupling by the pattern portion have a phase opposite to a phase before decoupling.

9. The antenna device of claim 1, wherein the pattern portion is configured such that hexagon-shaped patterns or rhombus-shaped patterns are repeatedly arranged.

10. The antenna device of claim 1, further comprising shielding walls disposed between the plurality of antenna elements to prevent direct decoupling between the plurality of antenna elements.
